(19) United States
(12) Patent Application Publication
(10) Pub. No.: US 2017/0227365 A1
(43) Pub. Date: Aug. 10, 2017

(54) INFORMATION PROCESSING APPARATUS AND TRAJECTORY INFORMATION CORRECTING METHOD

(71) Applicant: FUJITSU LIMITED, Kawasaki-shi (JP)

(72) Inventor: TAKASHI MIURA, Kawasaki (JP)

(73) Assignee: FUJITSU LIMITED, Kawasaki-shi (JP)

(21) Appl. No.: 15/401,729

(22) Filed: Jan. 9, 2017

(30) Foreign Application Priority Data
Feb. 10, 2016 (JP) 2016-023668

(51) Int. Cl. G01C 21/30; G01S 19/42

(52) U.S. Cl. CPC G01C 21/30; G01S 19/42

(57) ABSTRACT

An information processing apparatus acquires first trajectory data, including a first section where measurement positions were recorded and a second section where measurement positions are missing, and acquires first direction data indicating changes in direction of travel that have been measured. The information processing apparatus extracts, from a database, two or more second trajectory data based on a comparison between measurement positions in the first section and reference positions. The information processing apparatus selects one second trajectory data based on a comparison between a section in the first direction data corresponding to the second section and a section corresponding to the second section in second direction data associated with each of the two or more second trajectory data. The information processing apparatus supplements the second section of the first trajectory data with information on a road using the selected second trajectory data.

### CROSS-REFERENCE TO RELATED APPLICATION

This application is based upon and claims the benefit of priority of the prior Japanese Patent Application No. 2016-023668, filed on Feb. 10, 2016, the entire contents of which are incorporated herein by reference.

### FIELD

The embodiments discussed herein are related to an information processing apparatus and a trajectory information correcting method.

### BACKGROUND

It is now possible to measure the position of a moving object such as a vehicle using a positioning system like GPS (Global Positioning System). The position may be expressed using longitude and latitude, for example. However, the position measured by a positioning system includes an error in the region of around ten to several tens of meters. For this reason, a technology called “map matching” that matches a measured position against a road map to determine the road on which a moving object is present (for example, the road along which a vehicle is travelling or was travelling when measurement was performed) has been proposed.

As one example, a navigation apparatus that determines along which road a vehicle is presently travelling has been proposed. The proposed navigation apparatus continuously measures the position of the vehicle using GPS and calculates the direction of travel of the vehicle based on the latest measurement position and the previous measurement position. This navigation apparatus refers to a road map and searches for a plurality of roads within a predetermined range from the latest measurement position. The navigation apparatus calculates the angles between the direction of travel of the vehicle and straight lines representing the plurality of roads to narrow the selection down to roads where the angle is no greater than a threshold. The navigation apparatus then selects the closest road to the latest measurement position out of the narrowed selection of roads.

A navigation apparatus that is capable of using both satellite navigation that measures the position of a vehicle using GPS and autonomous navigation that estimates the position of a vehicle using vehicle-mounted sensors such as accelerometers has also been proposed. When the vehicle moves off a road and enters a location out of GPS reception, this proposed navigation apparatus searches a road map for roads that border this location and stores the roads. When performing map matching immediately after the vehicle has emerged from this location, the navigation apparatus preferentially matches the vehicle to the roads that have been registered in advance.

A navigation system that estimates, when using a road map where roads are expressed as single straight lines, which lane out of a plurality of lanes corresponds to the straight line has also been proposed. The proposed navigation apparatus calculates a correction distance between a measurement position measured using GPS and a corrected position on a road found by map matching. The navigation apparatus also specifies the lane width of the road on which the vehicle is travelling based on the road type. This navigation apparatus also detects white lines on the road using a vehicle-mounted camera and specifies the lane in which the vehicle is travelling. The navigation apparatus specifies the lane corresponding to a straight line on the road map from the correction distance, the lane width, and the lane in which the vehicle is travelling.

See, for example, the following documents:

Japanese Laid-open Patent Publication No. 2000-346662;

Japanese Laid-open Patent Publication No. 2007-127439; and

Japanese Laid-open Patent Publication No. 2012-37450

During map matching using a positioning system, it would be conceivable to store a plurality of movement trajectories for comparison purposes in advance in a database and to search these movement trajectories for comparison purposes to find a movement trajectory that most closely resembles the movement trajectory measured for a moving object. The measured movement trajectory and the movement trajectories for comparison purposes can be expressed as arrays of position information.

However, depending on the locations passed by the moving object, there are times when measurement of position using a positioning system is temporarily not performed. As examples, in locations with poor GPS reception, such as tunnels and underground roads, measurement of position using GPS may stop. This means that the movement trajectory of a moving object may include sections where position information is missing.

In a section where position information is missing, there may be two or more potential roads on which the moving object could be travelling. Here, it can be very difficult to sufficiently narrow the selection of potential roads on which the moving object may be travelling by simply comparing position information between the measured movement trajectory and the movement trajectories for comparison purposes. This may cause a lack of precision of map matching.

### SUMMARY

According to one aspect, there is provided an information processing apparatus including: a memory storing a plurality of second trajectory data including reference positions for a road so as to be associated with a plurality of second direction data indicating changes in direction of travel when travelling along the road; and a processor configured to perform a procedure including: acquiring first trajectory data, which includes measurement positions measured for a moving object and in which a first section where the measurement positions were recorded and a second section where the measurement positions are missing are present, and acquiring first direction data indicating changes in direction of travel measured for the moving object; extracting two or more second trajectory data out of the plurality of second trajectory data based on a comparison of the measurement positions in the first section and the reference positions; selecting one out of the extracted two or more second trajectory data based on a comparison of a section corresponding to the second section in the first direction data and a section corresponding to the second section in second direction data associated with each of the extracted two or more second trajectory data; and supplementing the second section of the first trajectory data with information on a road on which the moving object was travelling using the selected second trajectory data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an example of an information processing apparatus according to a first embodiment;

FIG. 2 depicts a traffic analyzing system according to a second embodiment;

FIG. 3 is a block diagram depicting example hardware of a vehicle-mounted apparatus;

FIG. 4 is a block diagram illustrating example hardware of a traffic analyzing apparatus;

FIG. 5 depicts an example of map matching using reference trajectories;

FIG. 6 depicts an example comparison between a query trajectory with missing points and a reference trajectory;

FIG. 7 is a block diagram depicting example functions of the traffic analyzing apparatus;

FIG. 8 depicts one example of query data;

FIG. 9 depicts an example of map data;

FIG. 10 depicts one example of a reference data table;

FIG. 11 depicts an example of search result data;

FIG. 12 depicts example correspondence between angles and characters;

FIG. 13 depicts one example of direction character data;

FIG. 14 depicts one example of matching result data;

FIG. 15 is a flowchart illustrating an example procedure of map matching;

FIG. 16 depicts an example comparison between a character string of query points and character strings of reference points; and

FIG. 17 is a flowchart depicting an example procedure of determining a road.

### DESCRIPTION OF EMBODIMENTS

Several embodiments will be described below with reference to the accompanying drawings, wherein like reference numerals refer to like elements throughout.

### First Embodiment

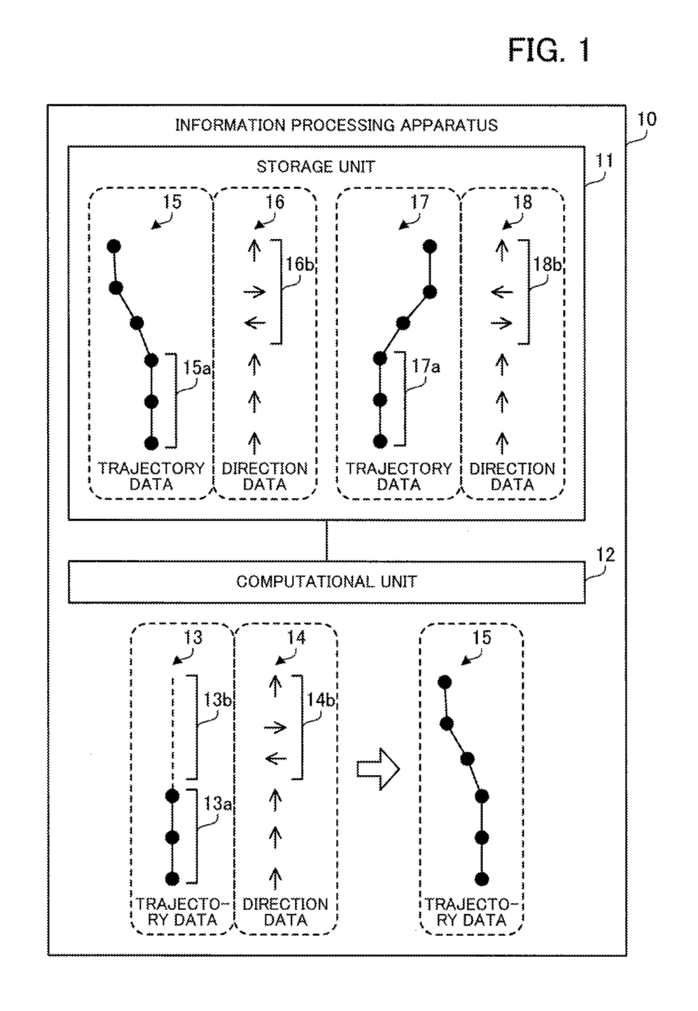

A first embodiment will be described first. FIG. 1 depicts an example of an information processing apparatus according to a first embodiment.

An information processing apparatus 10 according to the first embodiment performs map matching for a moving object such as a vehicle to determine the road on which the moving object is travelling. The information processing apparatus 10 may be a server apparatus that collects data from the moving object and performs analysis. In this case, the information processing apparatus 10 can also be used in a traffic control system. The information processing apparatus 10 may also be a terminal apparatus operated by the user. In this case, the information processing apparatus 10 may be mounted in or on the moving object.

The information processing apparatus 10 includes a storage unit 11 and a computational unit 12.

A database is formed in the storage unit 11. The storage unit 11 may be a volatile semiconductor memory such as RAM (Random Access Memory) or may be a nonvolatile storage apparatus such as an HDD (Hard Disk Drive) or flash memory. Note that although the information processing apparatus 10 is assumed to have a database in the first embodiment, the information processing apparatus 10 may refer to a database located outside the information processing apparatus 10.

The computational unit 12 performs map matching. As examples, the computational unit 12 may be a processor such as a CPU (Central Processing Unit) or a DSP (Digital Signal Processor). However, the computational unit 12 may include application-specific electronic circuitry, such as an ASIC (Application Specific Integrated Circuit) or an FPGA (Field Programmable Gate Array). The processor executes programs stored in a memory such as RAM (which may be the storage unit 11). The programs include a trajectory information correcting program in which the processing described below is written. In this specification, the expression “processor” also includes a group of processors (a so-called “multi-processor”).

The storage unit 11 stores a plurality of trajectory data (or “second trajectory data”) and a plurality of direction data (or “second direction data”) so as to be associated with one another. The plurality of trajectory data include trajectory data 15 and 17. The plurality of direction data include direction data 16 and 18. The trajectory data 15 and the direction data 16 are associated with one another and the trajectory data 17 and the direction data 18 are associated with one another.

Each trajectory data includes an array of reference positions. The array of reference positions indicates a movement path via one or two or more roads. Each reference position is expressed for example using coordinates for an earth coordinate system including latitude and longitude. Each direction data indicates changes in the direction of travel when travelling along the one or two or more roads indicated by the array of reference positions. As one example, each direction data includes an array of directions of travel corresponding to an array of reference positions.

The direction of travel may be classified into a low number of types, such as “straight ahead”, “turn left”, and “turn right”. As one example, the direction data 16 indicates changes in the direction of travel as “straight ahead, straight ahead, straight ahead, turn left, turn right, straight ahead”. The direction data 18 indicates changes in the direction of travel as “straight ahead, straight ahead, straight ahead, turn right, turn left, straight ahead”. Each direction data may include a symbol array (or “second symbol array”) where an array of directions of travel is expressed using a low number of different symbols.

The computational unit 12 acquires trajectory data 13 (or “first trajectory data”) and direction data 14 (or “first direction data”) for the moving object being analyzed. The trajectory data 13 includes an array of measurement positions measured at different times for the moving object. As one example, the trajectory data 13 is generated by the moving object using a positioning system such as GPS and is received from the moving object. Each measurement position is expressed for example using coordinates for an earth coordinate system including latitude and longitude.

The trajectory data 13 includes a section 13a (or “first section”) where measurement positions were recorded and a section 13b (or “second section”) where measurement positions are missing. The section 13b is a section where the moving object was passing a location where measurement of position using a positioning system was difficult, such as a tunnel, an underground road, or a location surrounded by tall buildings. In the section 13b, measurement positions are not recorded at the timing at which measurement positions were supposed to be recorded.

The direction data 14 indicates changes in the direction of travel measured for the moving object. As one example, the direction data 14 includes an array of directions of travel measured at different times. The direction data 14 may be generated by the moving object using a sensor device mounted on the moving object for example and is received from the moving object. Examples of sensor devices include a gyro sensor that measures angular velocity and a sensor that detects the rotational angle of the steering wheel. The direction data 14 may include angle data representing the angle between the direction of travel and a straight ahead direction for the moving object. As one example, the direction data 14 indicates changes in the direction of travel as “straight ahead, straight ahead, straight ahead, turn left, turn right, straight ahead”.

Here, it is assumed that even when position measurement using a positioning system is not performed, it is possible to measure the direction of travel using a sensor device. Therefore, in the direction data 14, changes in the direction of travel are recorded even for the section 14b corresponding to the section 13b where the measurement positions are missing. On the other hand, in the direction data 14, changes in the direction of travel do not need to be recorded for a section corresponding to the section 13a where measurement positions are recorded.

Once the trajectory data 13 and the direction data 14 have been acquired, the computational unit 12 compares the measurement positions of the section 13a of the trajectory data 13 with the reference positions in the respective trajectory data recorded in the storage unit 11. As one example, the computational unit 12 compares the measurement positions of the section 13a with the reference positions of a section 15a in the trajectory data 15 corresponding to the section 13a. Since the measurement positions in the section 13b are missing, the reference positions of the section in the trajectory data 15 corresponding to the section 13b do not need to be used in the comparison. Also, as one example, the computational unit 12 compares the measurement positions of the section 13a and the reference positions of a section 17a in the trajectory data 17 corresponding to the section 13a. Since the measurement positions in the section 13b are missing, the reference positions of the section in the trajectory data 17 corresponding to the section 13b do not need to be used in the comparison.

The computational unit 12 extracts two or more trajectory data from the plurality of trajectory data stored in the storage unit 11 based on the comparison between trajectory data described above. As one example, the computational unit 12 calculates a degree of similarity based on a comparison for each of the plurality of trajectory data stored in the storage unit 11. As examples, the computational unit 12 extracts a predetermined number of trajectory data in descending order of degree of similarity or trajectory data for which the degree of similarity is at least equal to a threshold. The extracted two or more trajectory data may be all or only some of the plurality of trajectory data stored in the storage unit 11. When a large number of trajectory data are stored in the storage unit 11, the extracted trajectory data will normally only be some out of the large number of stored trajectory data. It is assumed here that the trajectory data 15 and 17 are extracted.

When the trajectory data 15 and 17 have been extracted from the storage unit 11, the computational unit 12 extracts the section 14b, which corresponds to the section 13b where the measurement positions are missing, from the direction data 14. The computational unit 12 also acquires the direction data 16 and 18 associated with the trajectory data 15 and 17 from the storage unit 11. The computational unit 12 extracts the section 16b corresponding to the section 13b from the direction data 16 and extracts the section 18b corresponding to the section 13b from the direction data 18.

The computational unit 12 then compares the section 14b of the direction data 14 and the sections 16b and 18b of the direction data 16 and 18 and selects one out of the trajectory data 15 and 17. As one example, the computational unit 12 calculates the degree of similarity between the direction data based on comparisons between the section 14b and the sections 16b and 18b. As one example, the computational unit 12 selects the direction data with the highest degree of similarity and selects the trajectory data associated with the selected direction data. Here, the section 14b is expressed as “left turn, right turn, straight ahead”, the section 16b is expressed as “left turn, right turn, straight ahead”, and the section 18b is expressed as “right turn, left turn, straight ahead”. This means that the direction data 16 is more similar to the direction data 14 than the direction data 18, and as a result, the trajectory data 15 is selected out of the trajectory data 15 and 17.

When comparing the direction data, the computational unit 12 may convert the direction data 14 to a symbol array (or “first symbol array”) in which an array of directions of travel is expressed using a low number of different symbols. As one example, the computational unit classifies angles represented by the angle data included in the direction data 14 into a low number of types of direction of travel such as “straight ahead”, “turn left”, and “turn right” to convert to symbols corresponding to the types of direction of travel. Here, the computational unit 12 compares the symbol array expressing the section 14b with symbol arrays expressing the sections 16b and 18b. By comparing the symbol arrays together, it is possible to simply determine the degree of similarity in the directions of travel.

The computational unit 12 uses the selected trajectory data 15 to supplement information on the roads on which the moving object was moving for the section 13b of the trajectory data 13. As one example, the computational unit 12 associates each timing where a measurement position in the section 13b needs to be recorded with a reference position in the trajectory data 15, and assigns information on a road linked to the reference position to the timing.

According to the information processing apparatus 10 according to the first embodiment, the trajectory data 13 including the section 13a where measurement positions were recorded and the section 13b where the measurement positions are missing is acquired, and direction data 14 indicating changes in the measured direction of travel is acquired. Based on the section 13a of the trajectory data 13, the trajectory data 15 and 17 are extracted from the database. The trajectory data 15 is selected based on the section 14b of the direction data 14 corresponding to the section 13b.

By doing so, even when both the trajectory data 15 and 17 are similar to the section 13a where measurement positions were recorded, it is possible to narrow the selection of trajectory data to be used in map matching to the trajectory data 15. That is, even when trajectory data 15 and 17 indicate different paths for the section 13b where the measurement positions are missing, it is possible to use the direction data 14 to narrow the selection of paths on which the moving object moved in the section 13b to the path represented by the trajectory data 15. Therefore, it is possible to appropriately supplement the path information for the section 13b and improve the precision of map matching.

### Second Embodiment

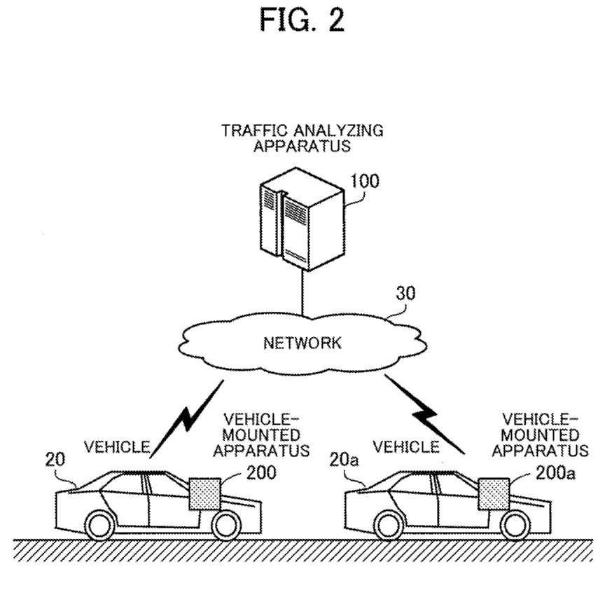

A second embodiment will now be described. FIG. 2 depicts a traffic analyzing system according to the second embodiment.

The traffic analyzing system according to the second embodiment includes a plurality of vehicles including vehicles 20 and 20a, a network 30, and a traffic analyzing apparatus 100. The traffic analyzing apparatus 100 corresponds to the information processing apparatus 10 according to the first embodiment.

The vehicles 20 and 20a are four-wheeled vehicles driven by people, for example. A vehicle-mounted apparatus 200 is mounted in or on the vehicle 20. A vehicle-mounted apparatus 200a is mounted in or on the vehicle 20a. The vehicle-mounted apparatuses 200 and 200a may be embedded apparatuses that perform running control or may be terminal apparatuses, such as navigation apparatuses, that are operated by the user. The vehicle-mounted apparatuses 200 and 200a are connected to the network 30 by wireless links.

The vehicle-mounted apparatus 200 measures the position of the vehicle 20 using GPS. The vehicle-mounted apparatus 200 also uses a sensor device such as a gyro sensor to measure the angle of the direction of travel of the vehicle 20. The angle represents the difference in the direction of travel from a state where the vehicle 20 is moving straight ahead (i.e., a forward direction where the vehicle 20 normally advances when the steering wheel is not rotated). The measured angle may be expressed as a rotational velocity per unit time measured in degrees per second. The vehicle-mounted apparatus 200 transmits data representing the position and/or angle of the vehicle 20 via the network 30 to the traffic analyzing apparatus 100. In the same way, the vehicle-mounted apparatus 200a measures the position of the vehicle 20a using GPS. The vehicle-mounted apparatus 200a also measures the angle of the direction of travel of the vehicle 20a. The vehicle-mounted apparatus 200a also transmits data representing the position and/or angle of the vehicle 20a via the network 30 to the traffic analyzing apparatus 100.

The traffic analyzing apparatus 100 is a server apparatus that analyzes the running state of vehicles on roads. The traffic analyzing apparatus 100 is connected to the network 30. The traffic analyzing apparatus 100 collects data on the position and/or angle of each of a plurality of vehicles via the network 30. The traffic analyzing apparatus 100 may be used in a traffic control system. As one example, the analysis result of the traffic analyzing apparatus 100 can be used in traffic control, such as control of traffic signals placed along roads.

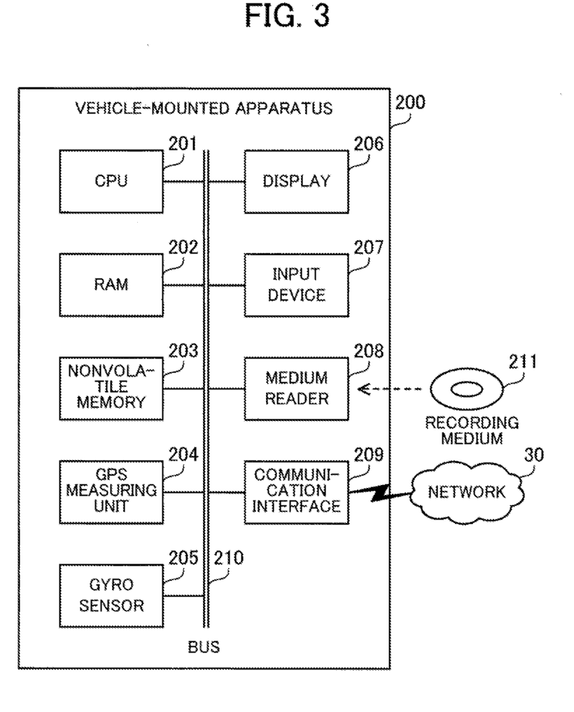

FIG. 3 is a block diagram depicting example hardware of a vehicle-mounted apparatus. The vehicle-mounted apparatus 200 includes a CPU 201, a RAM 202, a nonvolatile memory 203, a GPS measuring unit 204, a gyro sensor 205, a display 206, an input device 207, a medium reader 208, and a communication interface 209. These units of the vehicle-mounted apparatus 200 are connected to a bus 210. The vehicle-mounted apparatus 200a can be implemented using the same hardware as the vehicle-mounted apparatus 200.

The CPU 201 is a processor including computational circuitry that executes instructions of a program. The CPU 201 loads at least part of a program and data stored in the nonvolatile memory 203 into the RAM 202 and executes the program.

The RAM 202 is a volatile semiconductor memory that temporarily stores the program executed by the CPU 201 and data used in computation by the CPU 201. Note that the vehicle-mounted apparatus 200 may be equipped with other types of memory aside from RAM and may be equipped with a plurality of memories.

The nonvolatile memory 203 is a nonvolatile storage apparatus that stores software programs such as an OS (Operating System), driver software, and application software, as well as data. As the nonvolatile memory 203, it is possible to use ROM (Read Only Memory) or to use a rewritable memory such as flash memory. The vehicle-mounted apparatus 200 may also include another type of nonvolatile storage apparatus, such as an HDD, and may include various types of nonvolatile storage apparatus.

The GPS measuring unit 204 regularly receives GPS signals from GPS satellites and measures the position of the vehicle-mounted apparatus 200 based on the received GPS signals. The position of the vehicle-mounted apparatus 200 is expressed using coordinates for an earth coordinate system including latitude and longitude. In the second embodiment, the GPS measuring unit 204 measures the position of the vehicle-mounted apparatus 200 at one-second intervals. However, these measured positions are sampled one in ten times by the CPU 201 to convert to information at ten-second intervals. Also, depending on the environment in the periphery of the vehicle-mounted apparatus 200, the GPS measuring unit 204 may fail to properly receive GPS signals and therefore fail to measure the position. As one example, when the vehicle 20 is present in a tunnel or underground or tall buildings are present in the periphery of the vehicle 20, measurement of the position may fail. In this case, the coordinates corresponding to this time will be missing. Also, depending on the periphery of the vehicle-mounted apparatus 200, an error in a range of ten to several tens of meters may be included in the measured position.

The gyro sensor 205 is a sensor device that measures angular velocity (a rotational angle per unit time). The gyro sensor 205 is used to generate angle data indicating changes in the direction of travel of the vehicle 20. When the vehicle 20 is moving straight ahead, the angle is 0°. As described later, when the vehicle 20 is turning left, the angle has a positive value, while when the vehicle 20 is turning right, the angle has a negative value. The gyro sensor 205 measures the angle at at least the same timing (i.e., one-second intervals) as measurement of position by the GPS measuring unit 204 or at the same timing (ten-second intervals) as the measurement of position after sampling. The gyro sensor 205 is capable of measuring the angular velocity even when measurement of position using GPS has failed.

Note that as described later, the traffic analyzing system according to the second embodiment may classify the direction of travel of the vehicle 20 into one of three types that are “turn left”, “turn right”, and “other” (“straight ahead or substantially straight ahead”). For this reason, the vehicle-mounted apparatus 200 is capable of estimating the direction of travel of the vehicle 20 using data aside from the data of the gyro sensor 205. For example, the vehicle-mounted apparatus 200 may generate angle data using the rotational angle of the steering wheel provided in the vehicle 20. The vehicle-mounted apparatus 200 may also generate angle data using an illumination state of left and right indicators provided on the vehicle 20.

The display 206 displays images in accordance with instructions from the CPU 201. As examples of the display 206, it is possible to use a liquid crystal display (LCD) or an organic EL (OEL: Organic Electro-Luminescence) display. However, the display 206 may be outside the vehicle-mounted apparatus 200.

The input device 207 detects a user operation and outputs an input signal indicating the detected operation to the CPU 201. As examples of the input device 207, it is possible to use a keyboard and/or a touch panel. The vehicle-mounted apparatus 200 may include a plurality of types of input device. The input device 207 may be outside the vehicle-mounted apparatus 200.

The medium reader 208 is a reader apparatus that reads programs and/or data recorded on a recording medium 211. As examples of the recording medium 211, it is possible to use a semiconductor memory, a magnetic disk such as a flexible disk (FD) and an HDD, an optical disc such as a CD (Compact Disc) and a DVD (Digital Versatile Disc), a magneto-optical disc (MO), or the like. As one example, the medium reader 208 stores programs and data read from the recording medium 211 into the RAM 202 or the nonvolatile memory 203.

The communication interface 209 is connected to the network 30 by a wireless link and is a wireless communication interface that communicates with the traffic analyzing apparatus 100 via the network 30. In accordance with instructions from the CPU 201, the communication interface 209 transmits data, which associates time, coordinates that have been measured using the GPS measuring unit 204, and an angle that has been measured using the gyro sensor 205, to the traffic analyzing apparatus 100. The communication interface 209 may transmit data at the sampling intervals (ten-second intervals) for coordinates and may collectively transmit data for a plurality of times. As one example, the communication interface 209 may collectively transmit data for thirty times (samples) once in five minutes (since 30 multiplied by 10 seconds=300 seconds or 5 minutes).

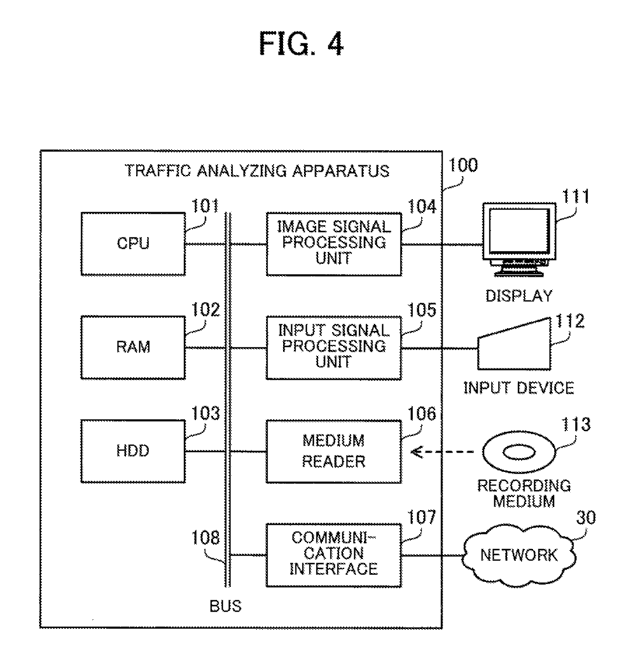

FIG. 4 is a block diagram illustrating example hardware of a traffic analyzing apparatus.

The traffic analyzing apparatus 100 includes a CPU 101, a RAM 102, an HDD 103, an image signal processing unit 104, an input signal processing unit 105, a medium reader 106, and a communication interface 107. These units provided in the traffic analyzing apparatus 100 are connected to a bus 108. The CPU 101 corresponds to the computational unit 12 in the first embodiment. The RAM 102 or the HDD 103 corresponds to the storage unit 11 in the first embodiment.

The CPU 101 is a processor including computational circuitry that executes instructions of a program. The CPU 101 loads at least part of the programs and data stored in the HDD 103 into the RAM 102 and executes the programs. Note that the CPU 101 may be equipped with a plurality of processor cores and the traffic analyzing apparatus 100 may be equipped with a plurality of processors. In this specification, the expression “processor” also includes a group of processors (a so-called “multi-processor”).

The RAM 102 is a volatile semiconductor memory that temporarily stores programs executed by the CPU 101 and data used in computation by the CPU 101.

The HDD 103 is a nonvolatile storage apparatus that stores software programs, such as an OS, middleware, and application software, as well as data. The programs include a trajectory information correcting program. Note that the traffic analyzing apparatus 100 may include another type of storage apparatus such as flash memory or an SSD (Solid State Drive).

The image signal processing unit 104 outputs images to the display 111 connected to the traffic analyzing apparatus 100 in accordance with instructions from the CPU 101. As examples of the display 111, it is possible to use any display such as a CRT (Cathode Ray Tube) display, a liquid crystal display, a plasma display, or an organic EL display.

The input signal processing unit 105 acquires an input signal from the input device 112 connected to the traffic analyzing apparatus 100 and outputs to the CPU 101. As examples of the input device 112, it is possible to use a pointing device such as a mouse, a touch panel, a touch pad, or a trackball, a keyboard, a remote controller, button switches, or the like. A plurality of types of input device may also be connected to the traffic analyzing apparatus 100.

The medium reader 106 is a reader apparatus that reads programs and data recorded on a recording medium 113. As examples of the recording medium 113, it is possible to use a magnetic disk, an optical disc, a magneto-optical disc, or a semiconductor memory. The medium reader 106 stores the program and data read from the recording medium 113 in the RAM 102 or the HDD 103.

The communication interface 107 is an interface that is connected to the network 30 and performs communication with other apparatuses via the network 30. The communication interface 107 may be a wired communication interface connected by a cable to a communication apparatus such as a switch, or a wireless communication interface connected by a wireless link to a base station.

Next, map matching performed by the traffic analyzing apparatus 100 is described.

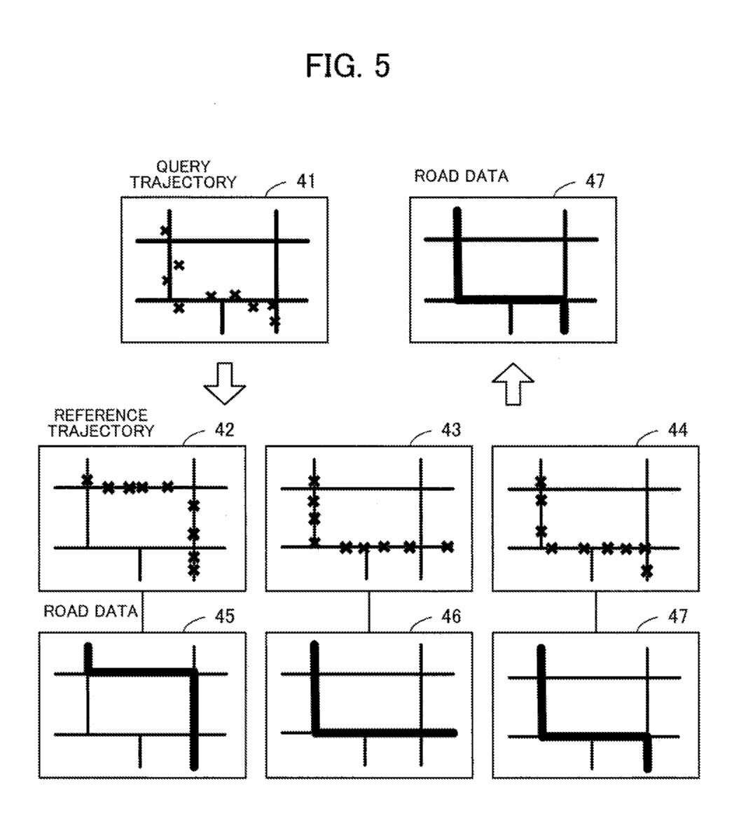

FIG. 5 depicts an example of map matching using reference trajectories.

Here, a situation is considered where the traffic analyzing apparatus 100 receives data from the vehicle-mounted apparatus 200 mounted in the vehicle 20 and then determines, based on the received data, the road on which the vehicle 20 is present at each time. The traffic analyzing apparatus 100 acquires a query trajectory 41. The query trajectory 41 is an array of coordinates (measurement positions) that have been measured by GPS during a five-minute period. However, each of the measured coordinates may include an error, and the positions may fail to accurately indicate positions on roads. Also, in the query trajectory 41, the coordinates for some of the measurement times may be missing due to measurement failures. For the sampling interval described earlier, the query trajectory 41 includes a maximum of 30 sets of coordinates.

The traffic analyzing apparatus 100 has a database including a plurality of reference trajectories and road data associated with the respective reference trajectories. In FIG. 5, reference trajectories 42 to 44 and road data 45 to 47 are given as examples. The road data 45 corresponds to the reference trajectory 42, the road data 46 corresponds to the reference trajectory 43, and the road data 47 corresponds to the reference trajectory 44.

Each of the reference trajectories 42 to 44 is an array of reference coordinates (or “reference positions”) that were generated based on an array of coordinates measured for a five-minute period when a vehicle (which may be a different vehicle to the vehicle 20) made a journey in the past. The reference trajectories 42 to 44 each include thirty sets of coordinates. The coordinates included in the reference trajectories 42 to 44 reflect the result of map matching in the past and have been corrected to appropriate coordinates on roads from coordinates that were measured in the past.

Each of the road data 45 to 47 is an array of identifiers of roads corresponding to the array of coordinates in one reference trajectory. The road data 45 to 47 each include thirty sets of coordinates. The identifiers of the roads included in the road data 45 to reflect the result of map matching in the past and indicate the road on which the vehicle was travelling at a given time (i.e., the road to which each reference position belongs).

One set of coordinates included in the reference trajectory 42 and one identifier included in the road data 45 correspond to each other. One set of coordinates included in the reference trajectory 43 and one identifier included in the road data 46 correspond to each other. One set of coordinates included in the reference trajectory 44 and one identifier included in the road data 47 correspond to each other. Since it is possible for a vehicle to move between a plurality of roads in five minutes, there is the possibility of each of the road data 45 to 47 including identifiers of a plurality of roads.

In the following description, a point to be expressed by a query trajectory is sometimes referred to as a “query point”. One query trajectory includes a predetermined number (for example, thirty) query points corresponding to a predetermined number of times where measurement is performed. Out of the predetermined number of query points, points where position measurement by GPS failed and the coordinates are missing are referred to as “missing points”. The points to be expressed by a reference trajectory are also sometimes referred to as “reference points”. One reference trajectory includes a predetermined number (for example, thirty) reference points corresponding to a predetermined number of times. It is assumed that out of the predetermined number of reference points, there are no points where the coordinates are missing.

On acquiring the query trajectory 41, the traffic analyzing apparatus 100 searches the plurality of reference trajectories stored in the database for reference trajectories with a high degree of similarity to the query trajectory 41. The degree of similarity between one query trajectory and one reference trajectory is calculated by comparing corresponding query points and reference points in order from the start of the arrays, so that the first query point and the first reference point, the second query point and the second reference point, . . . are compared in order from the earliest time.

In this second embodiment, the “distance” between the query trajectory and the reference trajectory is used as an index for the degree of similarity. The smaller the distance between the trajectories, the higher the degree of similarity, and the larger the distance between the trajectories, the lower the degree of similarity. The distance between the trajectories is the total of the distances between corresponding query points and reference points. As the distance between points, it is possible to use the square of the Euclidean distance. The square of the Euclidean distance is the sum of the squared difference in latitude and the squared difference in longitude.

As one example, the traffic analyzing apparatus 100 calculates the sum of the squared difference in latitude and the squared difference in longitude between the coordinates of the first query point and the coordinates of the first reference point and sets the result as the distance between the first points. The traffic analyzing apparatus 100 then calculates the sum of the squared difference in latitude and the squared difference in longitude between the coordinates of the second query point and the coordinates of the second reference point and sets the result as the distance between the second points. The traffic analyzing apparatus 100 calculates the distances between a maximum of thirty points and sets the total of the distances between the points as the distance between the trajectories. However, when there are missing points in a trajectory, the calculation of the distance between points is not performed for the missing points, which are ignored. When five missing points are present out of the thirty query points included in a query trajectory, the traffic analyzing apparatus 100 totals the distance between 25 pairs of points and sets the result as the distance between the trajectories.

After finding a reference trajectory with a high degree of similarity to the query trajectory 41 in this way, the traffic analyzing apparatus 100 extracts road data corresponding to the found reference trajectory. It is assumed here that the reference trajectory 44 is selected and the road data 47 is extracted. After this, the traffic analyzing apparatus 100 associates an identifier a road included in the road data 47 with each query point included in the query trajectory 41, that is, with each time indicated by the query trajectory 41.

The traffic analyzing apparatus 100 associates the first road identifier, which corresponds to the first reference point, with the first query point. The traffic analyzing apparatus 100 associates the second road identifier, which corresponds to the second reference point, with the second query point. Road identifiers are also associated with query points that are missing points where coordinates could not be measured. By doing so, it is possible to supplement the query trajectory 41 with information on the road on which the vehicle 20 was travelling at each time. That is, it is possible to complete map matching for the query trajectory 41.

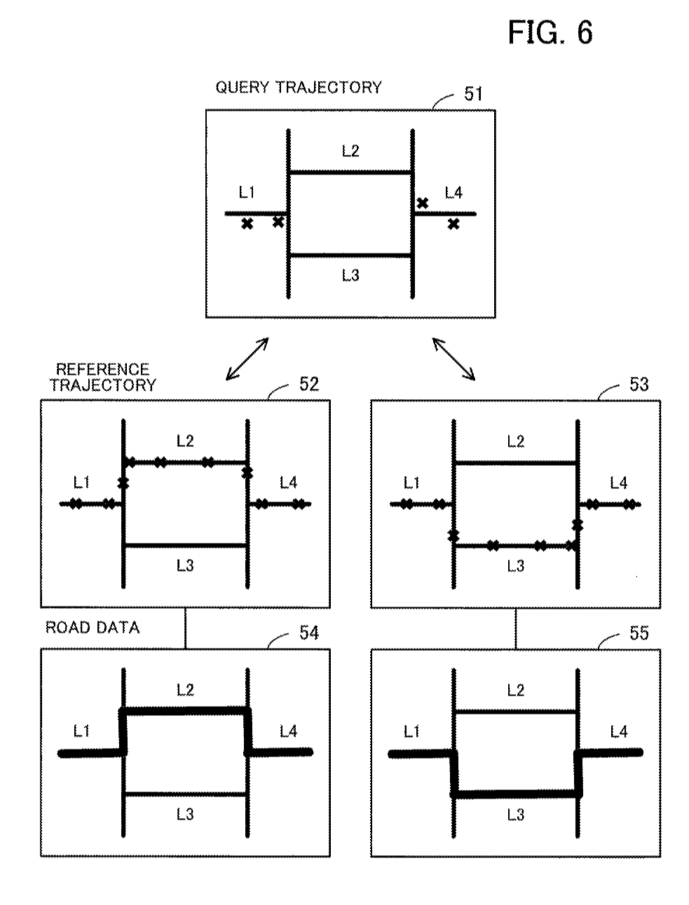

FIG. 6 depicts an example comparison between a query trajectory with missing points and a reference trajectory.

When the vehicle 20 travels on a road in a tunnel, on an underground road, or the like, there can be a long section with missing points. When this happens, the follow problem occurs during map matching. Here, it is assumed that the traffic analyzing apparatus 100 has acquired a query trajectory 51. It is also assumed that the reference trajectories 52 and 53 and the road data 54 and 55 are registered in the database. The road data 54 corresponds to the reference trajectory 52 and the road data 55 corresponds to the reference trajectory 53.

The query trajectory 51 includes coordinates measured when the vehicle 20 was travelling on a road L1 and coordinates measured when the vehicle 20 was travelling on a road L4. The roads L2 and L3 are present between the road L1 and the road L4. When the vehicle 20 moves from the road L1 to the road L4, one of the road L2 and the road L3 is passed. However, coordinates when the vehicle 20 was travelling on the road L2 or the road L3 are missing from the query trajectory 51.

The reference trajectory 52 includes reference points on the road L1, reference points on the road L2, and reference points on the road L4. The reference trajectory 52 does not include reference points on the road L3. The road data 54 indicates travel on the road L1, the road L2, and the road L4 when moving along the reference trajectory 52. The reference trajectory 53 includes reference points on the road L1, reference points on the road L3, and reference points on the road L4. The reference trajectory 53 does not include reference points on the road L2. The road data 55 indicates travel on the road L1, the road L3, and the road L4 when moving along the reference trajectory 53.

When comparing the query trajectory 51 and the reference trajectories 52 and 53, the query points for a midway section of the query trajectory 51 are missing points. For this reason, query points that are not missing points in the query trajectory 51 are compared with corresponding reference points in the reference trajectories 52 and 53. That is, query points and reference points relating to the road L1 are compared and query points and reference points relating to the road L4 are compared. Query points and reference points relating to the roads L2 and L3 are not compared.

As a result, both the reference trajectory 52 and the reference trajectory 53 have a high degree of similarity with the query trajectory 51. This is because the coordinates of the query points and the coordinates of the reference points relating to the road L1 being compared are close and the coordinates of the query points and the coordinates of the reference points relating to the road L4 being compared are also close. However, from only the coordinates included in the query trajectory 51, it is difficult to determine which out of the reference trajectories 52 and 53 is appropriate. This is because although the path on the section between the road L1 and the road L4 differs between the reference trajectory 52 and the reference trajectory 53, information on this section is missing from the query trajectory 51.

For this reason, the traffic analyzing apparatus 100 uses the angle of the direction of travel measured by the vehicles 20 and 20a to estimate the roads on which the vehicles were travelling during a section with consecutive missing points. The method of estimating roads based on the direction of travel according to this second embodiment will now be described.

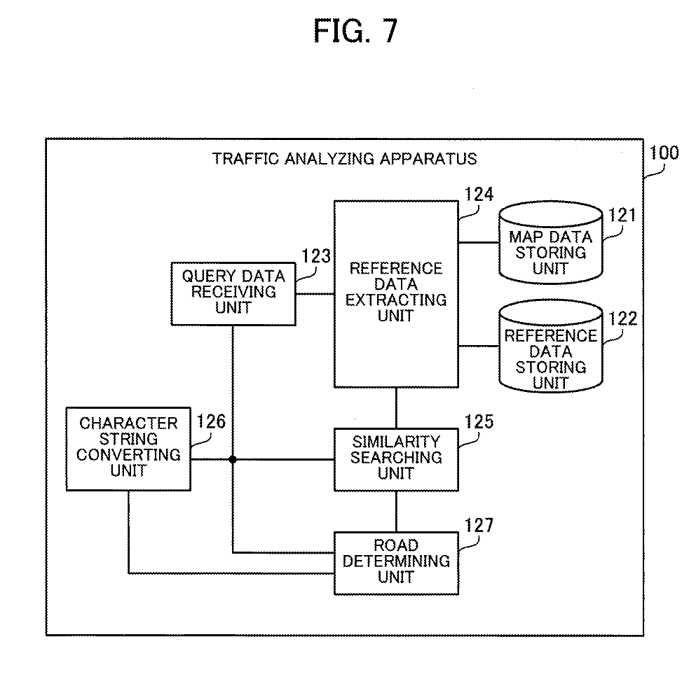

FIG. 7 is a block diagram depicting example functions of the traffic analyzing apparatus.

The traffic analyzing apparatus 100 includes a map data storing unit 121, a reference data storing unit 122, a query data receiving unit 123, a reference data extracting unit 124, a similarity searching unit 125, a character string converting unit 126, and a road determining unit 127. The map data storing unit 121 and the reference data storing unit 122 are implemented using storage regions reserved in the RAM 102 or the HDD 103, for example. The query data receiving unit 123, the reference data extracting unit 124, the similarity searching unit 125, the character string converting unit 126, and the road determining unit 127 are implemented for example by program modules executed by the CPU 101.

The map data storing unit 121 stores map data indicating a road map. The road map is divided into a plurality of areas. For this reason, the map data includes area data representing a range of latitude and a range of longitude of each area. The roads drawn on the road map are expressed by nodes representing base points, such as intersections, and links that connect two nodes. The road on which each vehicle is present can be expressed using the identifier of a link. For this reason, the map data includes node data representing the latitude and longitude of each node and link data representing each link.

The reference data storing unit 122 is a database formed in the traffic analyzing apparatus 100. The reference data storing unit 122 stores reference data relating to a plurality of reference trajectories. The reference data can be generated based on query data collected in the past from a plurality of vehicles and the results of map matching in the past. The reference data includes an array of reference points as each reference trajectory. The coordinates of the reference points are coordinates on roads after correction by map matching. The plurality of reference trajectories are classified into the plurality of areas. The reference data also includes road data indicating the road to which the each reference point belongs. The reference data includes direction character data that is associated with the reference points and expresses the direction of travel of a vehicle using single characters. The direction character data is classified to express one of “straight ahead”, “turn left”, and “turn right”.

The query data receiving unit 123 receives the query data for each of a plurality of vehicles including the vehicles 20 and 20a. The query data includes coordinates measured by GPS for the predetermined number of query points included in the query trajectory. As one example, the sampling interval is ten seconds and the query data includes a maximum of 30 sets of coordinates measured during a five-minute period. However, there are cases where some of the query points are so-called “missing points” due to the measurement of coordinates failing. The query data includes angle data indicating the angle of the direction of travel of the vehicle at the time of each query point.

When the query data receiving unit 123 has received the query data, the reference data extracting unit 124 extracts, from the reference data storing unit 122, reference data relating to roads close to the vehicle that transmitted the query data. More specifically, the reference data extracting unit 124 acquires the final coordinates in the query trajectory, refers to the map data storing unit 121, and specifies the area to which the final coordinates belong. The reference data extracting unit 124 extracts the reference data relating to the specified area from the reference data storing unit 122. The reference data extracting unit 124 then compares the final coordinates of the query trajectory and the final coordinates of each reference trajectory, narrows the selection to reference data where the final coordinates of the reference trajectory are present within a predetermined range from the final coordinates of the query trajectory, and outputs the selected reference data.

The similarity searching unit 125 compares the query trajectory included in the query data and the plurality of reference trajectories outputted by the reference data extracting unit 124 to calculate the degree of similarity (i.e., the distance from the query trajectory) of each reference trajectory. Out of the plurality of reference trajectories, the similarity searching unit 125 selects K reference trajectories with a high degree of similarity (i.e. where the distance is short) and outputs search result data. Here, “K” is an integer of two or more set in advance and as examples is set at 3 or 5. The search result data includes road data and direction character data corresponding to each of the K selected reference trajectories.

The character string converting unit 126 converts the angle data included in the query data to direction character data in accordance with the same conversion rules as the direction character data stored in the reference data storing unit 122. Each measured angle is converted into a single character indicating one of “straight ahead”, “turn left”, and “turn right”. In this second embodiment, it is assumed that “straight ahead” is expressed as “N”, “turn left” as “L”, and “turn right” as “R”. Examples of the correspondence between angle ranges and the characters are described later in this specification. The direction character data generated by the character string converting unit 126 is a character string (as one example, a character string that is 30 characters long) corresponding to the array of query points. As described earlier, measurement of angle is performed even when measurement of coordinates using GPS has failed. Therefore, the direction character data also includes characters corresponding to missing points.

The road determining unit 127 performs map matching that determines roads on which a vehicle was travelling at each time based on the query data, the search result data outputted by the similarity searching unit 125, and the direction character data outputted by the character string converting unit 126. The road determining unit 127 compares the direction character data (character string) of the query trajectory and the direction character data (character string) of the K reference trajectories and calculates a “cost” indicating the degree of similarity between the character strings. The “cost” can be referred to as the “distance” between the character strings and can also be referred to as the “editing cost” of correcting one character string to become the other character string.

Out of the K reference trajectories, the road determining unit 127 selects the reference trajectory corresponding to the character string with the highest degree of similarity (or lowest cost). The road determining unit 127 uses the road data associated with the selected reference trajectory to generate matching result data in which each query point in the query data is supplemented with the identifier of a road. Using the matching result data, it is possible to specify the road (singular) on which the vehicle was travelling at each time. The road determining unit 127 outputs matching result data. The matching result data may also be displayed on the display 111 and/or stored in the reference data storing unit 122.

Note that according to the second embodiment, the traffic analyzing apparatus 100 converts angles in the query data to characters. Alternatively, the vehicle-mounted apparatuses 200 and 200a may convert angles to characters and transmit query data including a character string to the traffic analyzing apparatus 100.

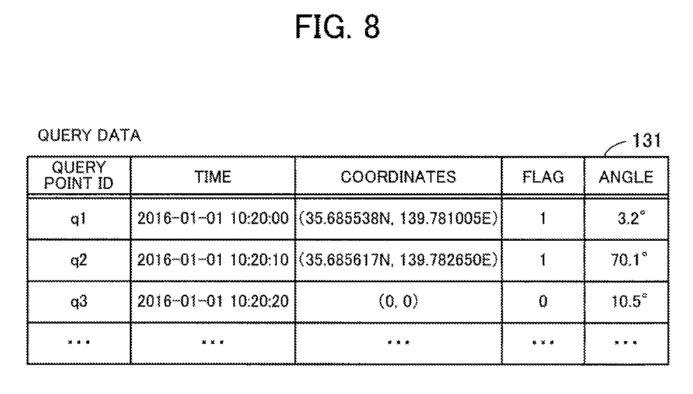

FIG. 8 depicts one example of the query data.

Query data 131 is received by the query data receiving unit 123 from the vehicle-mounted apparatus 200 mounted in the vehicle 20. The query data 131 includes query point ID, time, coordinates, flag, and angle columns.

The query point ID is an identifier for identifying a query point. The query data 131 includes a predetermined number of (for example, 30) query point IDs.

A “time” in the query data 131 is a point in time where coordinates are to be measured by the GPS measuring unit 204. The query data 131 includes times with a predetermined sampling interval (for example, ten-second intervals). The coordinates in the query data 131 are coordinates measured by the GPS measuring unit 204 and are expressed using latitude and longitude. These coordinates may include an error. Coordinates corresponding to times where measurement failed, that is coordinates corresponding to missing points are set at (0,0).

The flags are bits indicating whether coordinates were measured, or in other words, indicating whether query points are missing points. Query points where the flag is “1” indicate points that are not missing points (i.e., points where coordinates were measured) and query points where the flag is “0” indicate points that are missing points (i.e., points where coordinates are missing). The flags can be used as weightings when calculating the distance between the query trajectory and a reference trajectory. The flags can also be used as filter conditions when narrowing the comparison range when calculating the cost between the character strings that are direction character data.

The angles in the query data 131 are angles of the direction of travel measured by the gyro sensor 205 at each time where coordinates are to be measured by the GPS measuring unit 204. Angles corresponding to query points for which the flag is “0” (i.e., missing points) are also included in the query data 131. As described earlier, when the vehicle 20 is moving straight ahead, the angle is 0°, when the vehicle 20 is turning left, the angle is positive, and when the vehicle 20 is turning right, the angle is negative. The angle is larger the sharper the vehicle is turning left and the angle is smaller the sharper the vehicle is turning right.

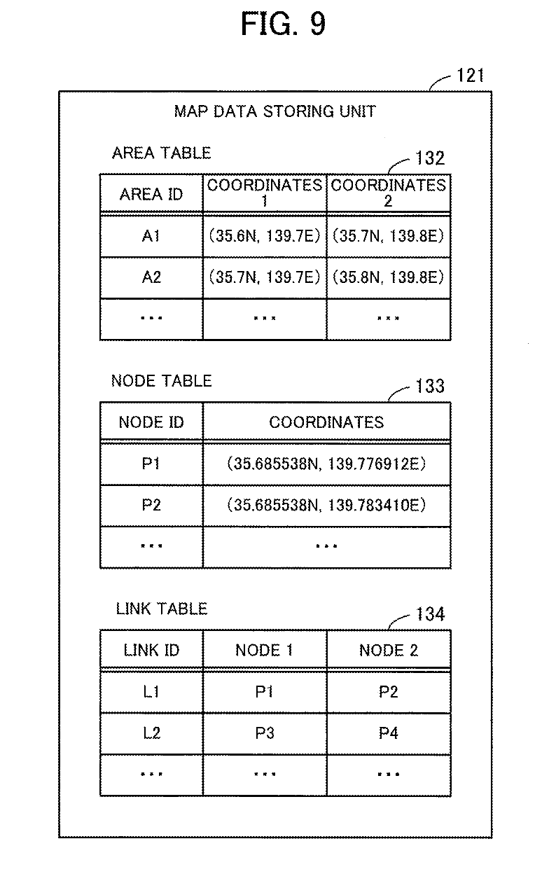

FIG. 9 depicts an example of map data.

An area table 132 is stored in the map data storing unit 121. The area table 132 has area ID, coordinates 1, and coordinates 2 columns. The area ID is an identifier assigned to each area when a road map is divided into a group of areas that are around ten kilometers by ten kilometers in size. Coordinates 1 are coordinates of one out of four end points that define an area and coordinates 2 are coordinates of another end point diagonally opposite the end point indicated by the coordinates 1. Coordinates 1 and coordinates 2 are expressed using latitude and longitude. Note that the area table 132 may include four sets of coordinates representing the four end points that define an area.

A node table 133 is stored in the map data storing unit 121. The node table 133 has node ID and coordinates columns. Node IDs are identifiers assigned to nodes that are base points (such as intersections) on roads drawn on the road map. The coordinates in the node table 133 are coordinates indicating the positions of nodes and are expressed using latitude and longitude.

A link table 134 is also stored in the map data storing unit 121. The link table 134 has link ID, node 1, and node 2 columns. Link IDs are identifiers assigned to links that are straight lines that join two nodes. The node ID assigned to a node at one end of a link is written in the node 1 column. The node ID assigned to a node at the other end of a link is written in the node 2 column.

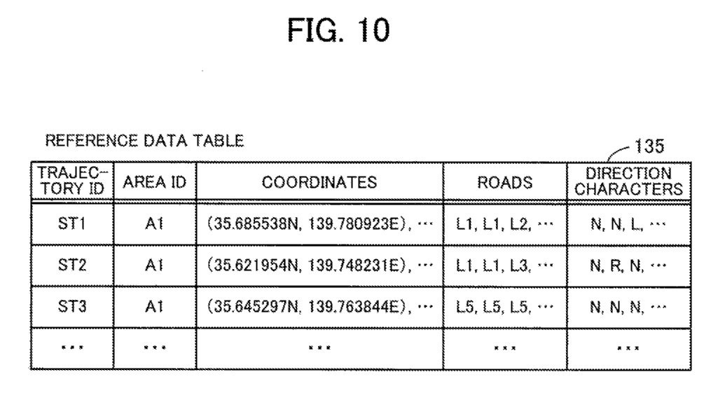

FIG. 10 depicts one example of a reference data table.

A reference data table 135 is stored in the reference data storing unit 122. The reference data table 135 has trajectory ID, area ID, coordinates, roads, and direction characters columns. The trajectory ID is an identifier assigned to a reference trajectory. The identifier of an area to which the reference trajectory belongs, out of the areas defined in the area table 132, is written in the area ID column.

The coordinates of a plurality of reference points included in a reference trajectory are listed in the coordinates column. As one example, the coordinates of thirty reference points that correspond to a five-minute period are listed in the coordinates column. Coordinates of the reference points are expressed using latitude and longitude. The coordinates of the reference points have been corrected from coordinates measured in the past and indicate points on a road.

Identifiers of roads associated with a plurality of reference points are listed in the roads column. As one example, thirty road identifiers corresponding to thirty reference points are listed in the roads column. As the road identifiers, link IDs defined in the link table 134 are used. The (single) road that corresponds to a (single) reference point is the road to which the reference point belongs, and has been determined by map matching in the past. A character string associated with a plurality of reference points is written in the direction characters column. As one example, a character string with a length of thirty characters corresponding to thirty reference points is written in the direction characters column. The respective characters are each one of “N” indicating “straight ahead”, “L” indicating “turn left”, and “R” indicating “turn right”. A single character corresponding to one reference point indicates the direction of travel of a vehicle when the coordinates were measured in the past, and can be generated by the same method as the characters for the query points.

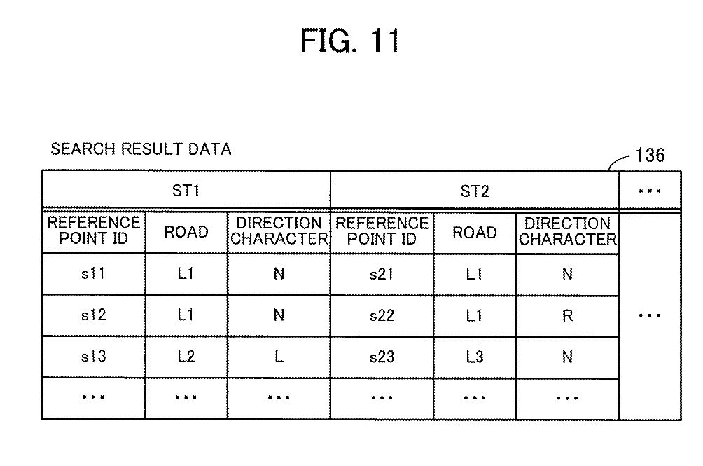

FIG. 11 depicts an example of search result data.

The search result data 136 is generated by the similarity searching unit 125. The search result data 136 includes data extracted from the reference data table 135 for K reference trajectories. The search result data 136 has reference point ID, road, and direction character columns for each of the K reference trajectories. Reference point IDs are identifiers for identifying reference points. The search result data 136 includes a predetermined number of (for example, 30) reference point IDs for each reference trajectory.

The road identifiers associated with the reference points in the reference data table 135 are written in the road column. Characters (“N”, “L”, or “R”) associated with the reference points in the reference data table 135 are written in the direction characters column.

Conversion of angles of the direction of travel to a character string will now be described.

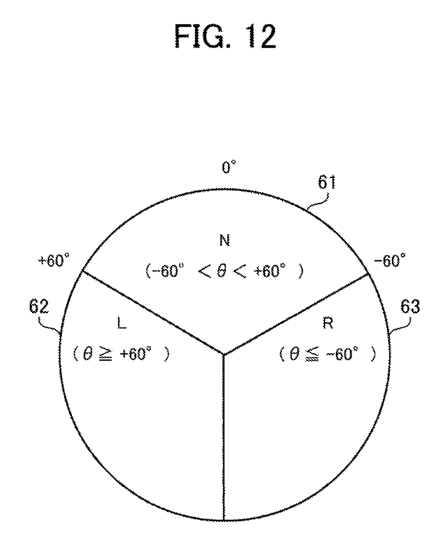

FIG. 12 depicts example correspondence between angles and characters. The character string converting unit 126 determines to which of three angle ranges 61 to an angle θ included in the query data belongs. The angle range 61 is a range of angles larger than −60° but smaller than +60° (−60°<θ<+60°). The angle range 62 is a range of angles of +60° and above (θ≧+60°. The angle range 63 is a range of angles of −60° and below (θ≦−60°.

The expression “θ=+60°” indicates that the direction of travel is displaced by 60° to the left from straight ahead. The expression “θ=−60°” indicates that the direction of travel is displaced by 60° to the right from straight ahead. When the angle θ belongs to the angle range 62, this means that the vehicle 20 was turning left. When the angle θ belongs to the angle range 63, this means that the vehicle 20 was turning right. When the angle θ belongs to the angle range 61, this means that the vehicle 20 was travelling straight ahead or substantially straight ahead. For this reason, when the angle θ belongs to the angle range 61, the character string converting unit 126 converts the angle θ to the character “N”. When the angle θ belongs to the angle range 62, the character string converting unit 126 converts the angle θ to the character “L”. When the angle θ belongs to the angle range 63, the character string converting unit 126 converts the angle θ to the character “R”.

Note that although classification is performed into three angle ranges in FIG. 12, it is also possible to classify into four or more angle ranges and convert to a character string that uses four or more characters. Also, although +60° and −60° are used as thresholds for the angle in FIG. 12, it is also possible to use other angles as the thresholds. The character strings included in the reference data table 135 can also be generated based on the same conversion rules.

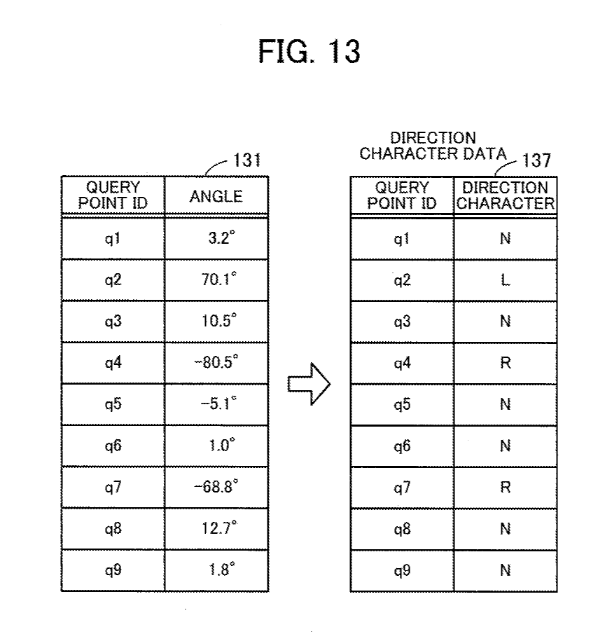

FIG. 13 depicts one example of direction character data.

The character string converting unit 126 generates the direction character data 137 that associates the query point IDs and characters based on the correspondence between query point IDs and angles depicted by the query data 131. The character string converting unit 126 converts each angle corresponding to a query point ID to a single character in accordance with the conversion rules in FIG. 12.

As one example, the query data 131 includes a list of angles “3.2°, 70.1°, 10.5°, −80.5°, −5.1°, 1.0°, −68.8°, 12.7°, 1.8°”. In this case, the direction character data 137 generated by the character string converting unit 126 includes the character string “N, L, N, R, N, N, R, N, N”.

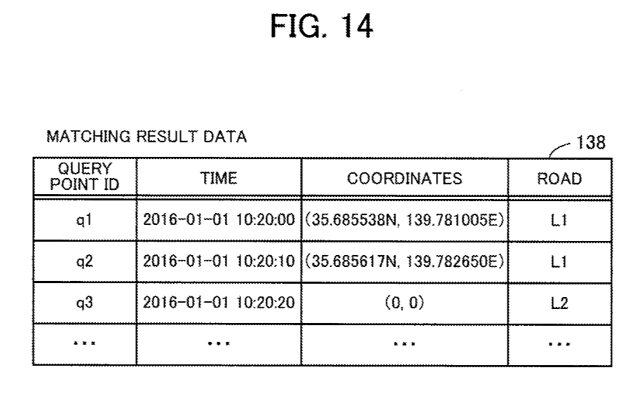

FIG. 14 depicts one example of matching result data.

The matching result data 138 is generated by the road determining unit 127. The matching result data 138 has query point ID, time, coordinates, and road columns. The query point ID, time, and coordinates in the matching result data 138 are the query point ID, time, and coordinates of the query data 131. Identifiers of roads (that is, link IDs) that have been supplemented to each time by the road determining unit 127 are written in the road column. From the matching result data 138, it is possible to specify which road the vehicle 20 was travelling on at each time.

Next, the procedure of the processing executed by the traffic analyzing apparatus 100 will be described

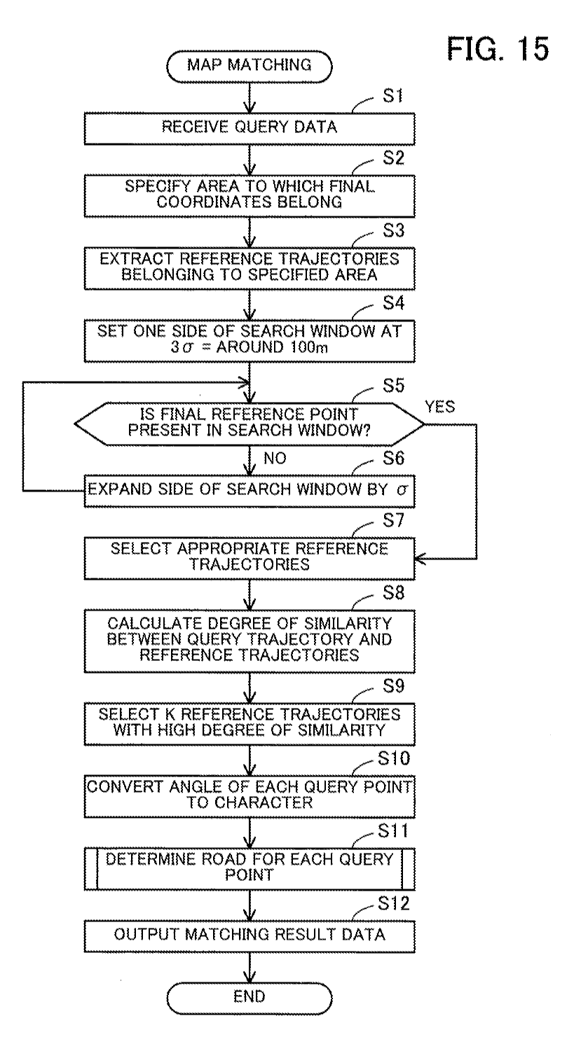

FIG. 15 is a flowchart illustrating an example procedure of map matching.

(S1) The query data receiving unit 123 receives the query data 131 via the network 30 from one vehicle-mounted apparatus (as one example, the vehicle-mounted apparatus 200 of the vehicle 20).

(S2) The reference data extracting unit 124 extracts the final coordinates (the coordinates with the latest time) out of the plurality of coordinates included in the query data 131. The reference data extracting unit 124 refers to the area table 132 stored in the map data storing unit 121 and specifies the area to which the extracted final coordinates belong. The specified area is an area where the latitude and longitude of the extracted final coordinates are larger than “coordinates 1” and smaller than “coordinates 2”.

(S3) The reference data extracting unit 124 extracts a plurality of reference trajectories that belong to the specified area from the reference data table 135 stored in the reference data storing unit 122.

(S4) The reference data extracting unit 124 sets a search window that is centered on the extracted final coordinates. One side of the search window is set at 3σ, which is equal to around 100 meters. Here, “σ” refers to the standard deviation of GPS errors.

(S5) The reference data extracting unit 124 determines whether a reference trajectory including the final reference point is present in the search window. When a reference trajectory is present, the processing proceeds to step S7, while when a reference trajectory is not present, the processing proceeds to step S6.

(S6) The reference data extracting unit 124 expands the length of one side of the search window by σ. The processing then returns to step S5 where it is determined once again whether a reference trajectory is present in the search window.

(S7) The reference data extracting unit 124 selects the reference trajectories that include a final reference point in the search window out of the reference trajectories extracted in step S3. That is, the reference data extracting unit 124 selects the reference trajectories that are closest to the extracted final coordinates.

(S8) The similarity searching unit 125 calculates the degree of similarity between the query trajectory indicated by the query data 131 and each of the reference trajectories selected in step S7. More specifically, the similarity searching unit 125 compares points in corresponding positions in the order between the array of query points written in the query data 131 and the array of reference points written in the reference data table 135 and calculates the distance between the trajectories (for example, the sum of squares of Euclidean distances between points) using the method described earlier. However, query points that are missing points where the coordinates are missing and reference points corresponding to these missing points are ignored.

(S9) The similarity searching unit 125 selects K reference trajectories in descending order of degree of similarity to the query trajectory, that is, K reference trajectories in ascending order of the distance calculated in step S8. The similarity searching unit 125 generates the search result data 136 from the reference data (which includes the road data and direction character data) relating to the selected reference trajectories.

(S10) The character string converting unit 126 converts each of the plurality of angles included in the query data 131 to single characters in accordance with the conversion rules described earlier. The character string converting unit 126 generates direction character data 137 including a character string corresponding to the array of query points. As one example, each angle is converted into one of “N” indicating “straight ahead”, “L” indicating “turn left”, and “R” indicating “turn right”.

(S11) The road determining unit 127 uses the query data 131, the search result data 136 generated in step S9, and the direction character data 137 generated in step S10 to determine which roads correspond to each of the plurality of query points. This determination of roads is described in detail later.

(S12) The road determining unit 127 supplements the query data 131 with identifiers of roads on which the vehicle-mounted apparatus was present when the query data 131 was transmitted to generate the matching result data 138. The road determining unit 127 outputs the matching result data 138. The road determining unit 127 may also display the matching result data 138 on the display 111 and/or store the matching result data 138 in the reference data storing unit 122 or the like.

Next, the determination of roads in step S11 will be described.

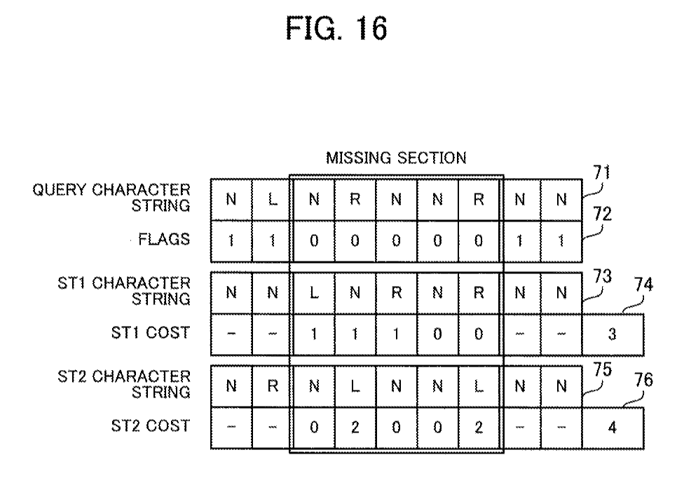

FIG. 16 depicts an example comparison between a character string of query points and character strings of reference points.

As one example, the road determining unit 127 acquires character strings 71, 73, and 75 and a flag array 72. The character string 71 is the character string included in the direction character data 137, that is, a character string corresponding to the query trajectory. The flag array 72 is an array of flags included in the query data 131. The flag array 72 indicates which query points in the query trajectory are missing points.

The character string 73 is a character string of the reference trajectory ST1 included in the search result data 136, that is, the character string corresponding to the reference trajectory ST1 selected by the similarity searching unit 125. The character string 75 is a character string of the reference trajectory ST2 included in the search result data 136, that is, the character string corresponding to the reference trajectory ST2 selected by the similarity searching unit 125.

More specifically, the character string 71 is “N, L, N, R, N, N, R, N, N”. The flag array 72 is “1, 1, 0, 0, 0, 0, 0, 1, 1”. The character string 73 is “N, N, L, N, R, N, R, N, N”. The character string 75 is “N, R, N, L, N, N, L, N, N”.

The road determining unit 127 extracts the characters corresponding to missing points from the character string 71 corresponding to the query trajectory. The characters corresponding to missing points are characters corresponding to query points for which the flags are “0”. A section where missing points are continuous in the query trajectory can also be referred to as a “missing section”. In the same way, the road determining unit 127 extracts characters corresponding to missing points (characters of a missing section) from the character string 73 corresponding to the reference trajectory ST1. The road determining unit 127 also extracts characters corresponding to missing points (characters of a missing section) from the character string 75 corresponding to the reference trajectory ST2.

More specifically, the road determining unit 127 extracts “N, R, N, N, R” that are the third to seventh characters from the character string 71. The road determining unit 127 also extracts “L, N, R, N, R” that are the third to seventh characters from the character string 73. The road determining unit 127 also extracts “N, L, N, N, L” that are the third to seventh characters from the character string 75.

The road determining unit 127 calculates the cost by comparing corresponding characters between the missing section of the character string 71 and the missing section of the character string 73. When doing so, the cost of characters outside the missing section does not need to be calculated. The road determining unit 127 calculates a total cost 74 produced by totaling the cost for the reference trajectory ST1. The road determining unit 127 also calculates the cost by comparing corresponding characters between the missing section of the character string 71 and the missing section of the character string 75. The road determining unit 127 calculates a total cost 76 produced by totaling the cost for the reference trajectory ST2.

The cost of the two characters being compared is the editing cost incurred when correcting one character to the other character. When the two characters match, the cost is zero. When two characters correspond to two angle ranges that are adjacent, the cost is 1. When two characters correspond to two angle ranges that are not adjacent, the cost is 2 (or 3 or higher). This means that the cost increases when the direction of travel is completely different, as between turning left and turning right.

More specifically, the cost for N and N, L and L, and R and R pairs is 0. The cost for N and L, and N and R pairs is 1. The cost for L and R is 2. Therefore, the costs of the missing section of character string 73 are “1, 1, 1, 0, 0” so that the total cost 74 is calculated as 3. The costs of the missing section of character string 75 are “0, 2, 0, 0, 2” so that the total cost 76 is calculated as 4. The number of characters that differ to the character string 71 is 3 for the missing section in the character string 73 and is 2 for the missing section in the character string 75, and so is lower for the character string 73. However, the total cost 76 of the character string 75 is higher than the total cost 74 of the character string 73. This is because the character string 75 has a tendency for the direction of travel to be directly opposite to the character string 71.

As a result, the character string 73 that has the lower cost out of the character strings 73 and 75 is determined to be similar to the character string 71. Therefore, the reference trajectory ST1 is determined out of the reference trajectories ST1 and ST2 to be close to the movement path of the vehicle when the query data 131 was transmitted.

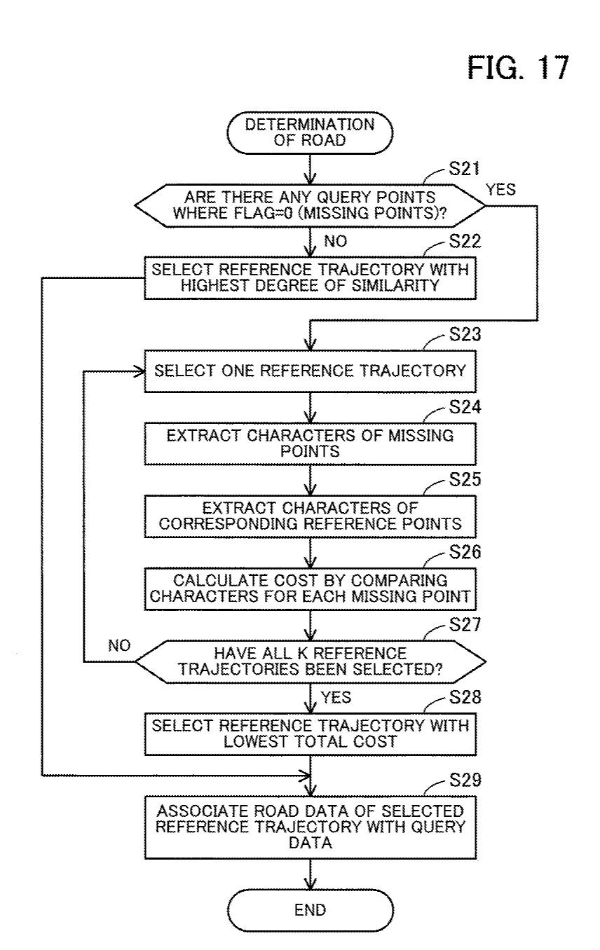

FIG. 17 is a flowchart depicting an example procedure of determining a road.

(S21) The road determining unit 127 determines whether query points where the flag is 0 (i.e., missing points) are present in the query data 131. When missing points are present, the processing proceeds to step S23, while when missing points are not present, the processing proceeds to step S22.

(S22) The road determining unit 127 selects the reference trajectory with the highest degree of similarity (i.e., the shortest distance) calculated by the similarity searching unit 125 out of the K reference trajectories written in the search result data 136. The degrees of similarity of the K reference trajectories may also be written in the search result data 136. The road determining unit 127 may also enquire to the similarity searching unit 125 about the degrees of similarity of the K reference trajectories or about the reference trajectory with the highest degree of similarity. The processing then proceeds to step S29.

(S23) The road determining unit 127 selects one reference trajectory from the K reference trajectories written in the search result data 136.

(S24) The road determining unit 127 extracts all of the characters corresponding to missing points from the character string written in the direction character data 137.

(S25) The road determining unit 127 extracts, for the reference trajectory selected in step S23, all of the characters of the reference points corresponding to missing points from the character string written in the search result data 136.

(S26) The road determining unit 127 compares a character in the query trajectory extracted in step S24 and a character in the reference trajectory extracted in step S25 for each missing point and calculates the cost. When the two characters are N and N, L and L, or R and R, the cost is 0. When the two characters are N and L or N and R, the cost is 1. When the two characters are L and R, the cost is 2. The road determining unit 127 then calculates the total cost by totaling the costs of all of the missing points.

(S27) The road determining unit 127 determines whether all of the K reference trajectories have been selected in step S23. When all of the K reference trajectories have been selected, the processing proceeds to step S28, while when there is a reference trajectory yet to be selected, the processing returns to step S23.

(S28) The road determining unit 127 selects the reference trajectory with the lowest total cost calculated in step S26 out of the K reference trajectories.

(S29) The road determining unit 127 acquires, from the search result data 136, the road data for the reference trajectory selected in step S22 or step S28. The road determining unit 127 associates the acquired road data with the query data 131. That is, for each query point written in the query data 131, the road determining unit 127 associates the identifier of the road (i.e., the link ID) to which a reference point corresponding to the query point belongs with the query point.

According to the traffic analyzing system according to the second embodiment, the query data 131 in which times are associated with GPS coordinates is supplemented with identifiers of roads using map matching. By doing so, it is possible to specify which roads the vehicles 20 and 20a were travelling on at each time.

Also, even when the query data 131 has a missing section where GPS coordinates are missing, it is possible to narrow the selection of movement trajectories of the vehicles 20 and 20a using angles that were measured using the gyro sensor 205 or the like. Accordingly, it is possible to supplement even missing sections with identifiers of roads, which improves the precision of map matching. Changes in the direction of travel of the vehicles 20 and 20a are converted to character strings that are expressed using a low number of different characters (for example, the three characters “N”, “L”, and “R”) and are compared with character strings in a database. By doing so, it is possible to simplify the comparison process while maintaining a sufficient level of precision for distinguishing between a plurality of paths.

Note that as described earlier, the information processing in the first embodiment can be realized by having the information processing apparatus 10 execute a program. The information processing in the second embodiment can be realized by having the traffic analyzing apparatus 100 or the vehicle-mounted apparatuses 200 and 200a execute a program.

The program can be recorded in advance on a computer-readable recording medium (for example, the recording media 113 and 211). As examples of the recording medium, it is possible to use a magnetic disk, an optical disc, a magneto-optical disc, or a semiconductor memory. A flexible disk and an HDD are examples of magnetic disks. A CD, CD-R (Recordable), a CD-RW (Rewritable), a DVD, and a DVD-R/RW are examples of optical discs. The program may be distributed having been recorded on a portable recording medium. Here, the program may be executed after being copied from the portable recording medium to another recording medium (as examples, the HDD 103 or the nonvolatile memory 203).

According to the embodiments, it is possible to improve the precision of map matching when measurement positions are missing in a section.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory storing a plurality of second trajectory data including reference positions for a road so as to be associated with a plurality of second direction data indicating changes in direction of travel when travelling along the road; and
a processor configured to perform a procedure including:
acquiring first trajectory data, which includes measurement positions measured for a moving object and in which a first section where the measurement positions were recorded and a second section where the measurement positions are missing are present, and acquiring first direction data indicating changes in direction of travel measured for the moving object;
extracting two or more second trajectory data out of the plurality of second trajectory data based on a comparison of the measurement positions in the first section and the reference positions;
selecting one out of the extracted two or more second trajectory data based on a comparison of a section corresponding to the second section in the first direction data and a section corresponding to the second section in second direction data associated with each of the extracted two or more second trajectory data; and
supplementing the second section of the first trajectory data with information on a road on which the moving object was travelling using the selected second trajectory data.

2. The information processing apparatus according to claim 1, wherein the procedure further includes converting the acquired first direction data to a first symbol array using symbol conversion rules that associate ranges of the direction of travel with types of symbol,
each of the plurality of second direction data includes a second symbol array, and
the selecting of the second trajectory data includes selecting one out of the extracted two or more second trajectory data based on a comparison between the first symbol array and the second symbol arrays.

3. The information processing apparatus according to claim 2,
wherein the first direction data includes a plurality of angles measured for the direction of travel of the moving object at different times using a sensor device provided in the moving object, and
the converting to the first symbol string includes converting the plurality of angles to the first symbol string.

4. A trajectory information correcting method comprising:
acquiring, by a processor, first trajectory data, which includes measurement positions measured for a moving object and in which a first section where the measurement positions were recorded and a second section where the measurement positions are missing are present, and acquiring first direction data indicating changes in direction of travel measured for the moving object;
extracting, by the processor, from a database storing a plurality of second trajectory data including reference positions for a road so as to be associated with a plurality of second direction data indicating changes in direction of travel when travelling along the road, two or more second trajectory data out of the plurality of second trajectory data based on a comparison of the measurement positions in the first section and the reference positions;
selecting, by the processor, one out of the extracted two or more second trajectory data based on a comparison of a section corresponding to the second section in the first direction data and a section corresponding to the second section in second direction data associated with each of the extracted two or more second trajectory data; and
supplementing, by the processor, the second section of the first trajectory data with information on a road on which the moving object was travelling using the selected second trajectory data.

5. A non-transitory computer-readable storage medium storing a computer program that causes a computer to perform a procedure comprising:
acquiring first trajectory data, which includes measurement positions measured for a moving object and in which a first section where the measurement positions were recorded and a second section where the measurement positions are missing are present, and acquiring first direction data indicating changes in direction of travel measured for the moving object;
extracting, from a database storing a plurality of second trajectory data including reference positions for a road so as to be associated with a plurality of second direction data indicating changes in direction of travel when travelling along the road, two or more second trajectory data out of the plurality of second trajectory data based on a comparison of the measurement positions in the first section and the reference positions;
selecting one out of the extracted two or more second trajectory data based on a comparison of a section corresponding to the second section in the first direction data and a section corresponding to the second section in second direction data associated with each of the extracted two or more second trajectory data; and
supplementing the second section of the first trajectory data with information on a road on which the moving object was travelling using the selected second trajectory data.
